(19) United States
(12) Patent Application Publication
(10) Pub. No.: US 2004/0155874 A1
(43) Pub. Date: Aug. 12, 2004

(54) Apparatus for driving flat display panel

(75) Inventor: Seong-Hak Moon, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/757,476

(22) Filed: Jan. 15, 2004

(30) Foreign Application Priority Data
Feb. 12, 2003 (KR) 08876/2003

(51) Int. Cl. G09G 5/00

(52) U.S. Cl. 345/204

(57) ABSTRACT

An apparatus for driving a flat display panel includes a scan driving unit for controlling an upper voltage value and a lower voltage value which are applied to an IC (Integrated Circuit) for driving a scan electrode of a flat display panel.

### BACKGROUND OF THE INVENTION

1. Field of the Invention

The present invention relates to a flat display panel, and particularly, to an apparatus for driving a flat display panel.

2. Description of the Background Art

In general, a flat display panel is a next-generation digital multimedia display device such as a liquid crystal display (LCD), a field emission display (FED), a plasma display panel (PDP), an Electro-luminescence (EL) or the like.

Especially, the FED among those flat display panels is classified into a Tip type FED and an MIM (Metal Insulator Metal) type FED. In the Tip type FED, a voltage of 10V˜100V should be applied between a gate electrode and a scan electrode, and a difference of applied voltages is varied according to a diameter of a gate hole.

On the other hand, the MIM type FED is advantageous in that power consumption is relatively small since a voltage of 1V˜10V is applied between the gate electrode and the scan electrode.

The MIM type FED having such a characteristic has a very high resistance component and a high condenser component and therefore needs a driving IC (integrated circuit) which can drive a display panel with a relatively high current value. An apparatus for driving a flat display panel for driving such a MIM type FED will now be described with reference to FIG. 1.

FIG. 1 is a block diagram showing an apparatus for driving a general flat display panel.

As shown therein, an apparatus for driving a general flat display panel includes: a control unit 130 for outputting a control signal on the basis of horizontal and vertical synchronous signals of an inputted image signal; a data processing unit 110 for converting the inputted image signal to image data on the basis of the control signal inputted from the control unit 130; a data driving unit 120 for outputting a data pulse on the basis of the converted image data; a scan driving unit 140 for outputting a scan pulse on the basis of the inputted control signal; and a display panel 150 for displaying the image signal on the basis of the data pulse inputted from the data driving unit 120 and the scan pulse inputted from the scan driving unit 140.

An operation principle of an apparatus for driving the MIM type FED in accordance with the conventional art constructed as above will now be roughly described.

First, the data processing unit 110 receives an image signal, and the control unit 130 receives a horizontal synchronous signal (H-sync) and a vertical synchronous signal (V-sync) of the image signal. The control unit 130 generates a control signal on the basis of the inputted horizontal synchronous signal and the inputted vertical synchronous signal and outputs the generated control signal to the data processing unit 110 and the scan driving unit 140.

The data processing unit 110 converts the inputted image signal to image data, on the basis of the inputted control signal, and outputs the converted image data to the data processing unit 120.

The data processing unit 120 generates a data pulse on the basis of the image data inputted from the data processing unit 110 and outputs the generated data pulse to the display panel 150, and the scan driving unit 140 generates a scan pulse on the basis of the control signal inputted from the control unit 130 and outputs the generated scan pulse to the display panel 150.

Accordingly, the display panel 150 displays the image signal on the basis of the inputted data pulse and the inputted scan pulse. Hereinafter, a detailed construction of a scan driving unit for outputting the scan pulse in the MIM type FED in accordance with the conventional art will now be described with reference to FIG. 2.

FIG. 2 is a block diagram showing a construction of a scan driving unit of FIG. 1 in detail.

As shown therein. The scan driving unit in accordance with the present invention includes: a timing control unit 141 for outputting a timing control signal; a first buffer 142 for temporarily storing the timing control signal inputted from the timing control unit 141; a photocoupler 143 for insulating an input terminal and an output terminal for the timing control signal; a second buffer 144 for temporarily storing the timing control signal inputted from the photocoupler 143; a pulse generating unit 210 for outputting a voltage of a predetermined level on the basis of a switching control signal; and a scan driving IC 145 for outputting a voltage of a predetermined level inputted from the pulse generating unit 210, on the basis of the timing control signal inputted from the second buffer 144.

An operation principle of the scan driving unit in accordance with the conventional art constructed as above will now be described in detail.

First, the timing control unit 141 outputs a timing control signal on the basis of a control signal inputted from the control unit 130. At this time, the timing control signal is outputted to the scan driving IC 145 through the first buffer 142, the photocoupler 143 and the second buffer 144.

The pulse generating unit 210 selectively outputs one of voltages of predetermined levels (−5V, 0V, 5V) on the basis of first and second and third switching control signals (SC1, SC2, SC3) inputted from the control unit 130. That is, when receiving the first switching control signal SC1, the pulse generating unit 210 outputs a pulse corresponding to a voltage of 5V to the scan driving IC 145, and when receiving the second switching control signal SC2, the pulse generating unit 210 outputs a pulse corresponding to a voltage of −5V to the scan driving IC 145. In addition, when receiving the third switching control signal SC3, the pulse generating unit 210 outputs a pulse corresponding to a voltage of 0V to the scan driving IC 145.

Accordingly, the scan driving unit 140 outputs a pulse corresponding to one of inputted voltages of predetermined level (−5V, 0V, 5V) to the display panel 150 on the basis of the timing control signal inputted from the second buffer 144.

However, the apparatus for driving the MIM type FED in accordance with the conventional art is disadvantageous in that a high-priced special scan driving IC for driving a display panel with a relatively high current is required since the MIM type FED has a high resistance component and a condenser component.

### SUMMARY OF THE INVENTION

Therefore, an object of the present invention is to provide an apparatus for driving a flat display panel capable of reducing a unit cost of a product by controlling an upper voltage value and a lower voltage value which are applied to an IC for driving a scan electrode of a flat display panel.

Another object of the present invention is to provide an apparatus for driving a flat display panel capable of providing various pulses according to a kind of flat display panel by controlling an upper voltage value and a lower voltage value which are applied to an IC for driving an scan electrode of a flat display panel.

To achieve these and other advantages and in accordance with the purpose of the present invention, as embodied and broadly described herein, there is provided an apparatus for driving a flat display panel including a scan driving unit for controlling an upper voltage value and a lower voltage value which are applied to an IC for driving a scan electrode of a flat display panel.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a unit of this specification, illustrate embodiments of the invention and together with the description serve to explain the principles of the invention.

In the drawings:

FIG. 1 is a block diagram showing an apparatus for driving a general flat display panel;

FIG. 2 is a block diagram showing a detailed construction of a scan driving unit of FIG. 1;

FIG. 3 is a block diagram showing a detailed construction of a scan driving unit in accordance with the present invention;

FIG. 4 is a view for explaining a principle of a scan driving unit of FIG. 3; and

FIGS. 5A˜5E are graphs showing various scan pulse waveforms of a scan driving unit in accordance with the present invention.

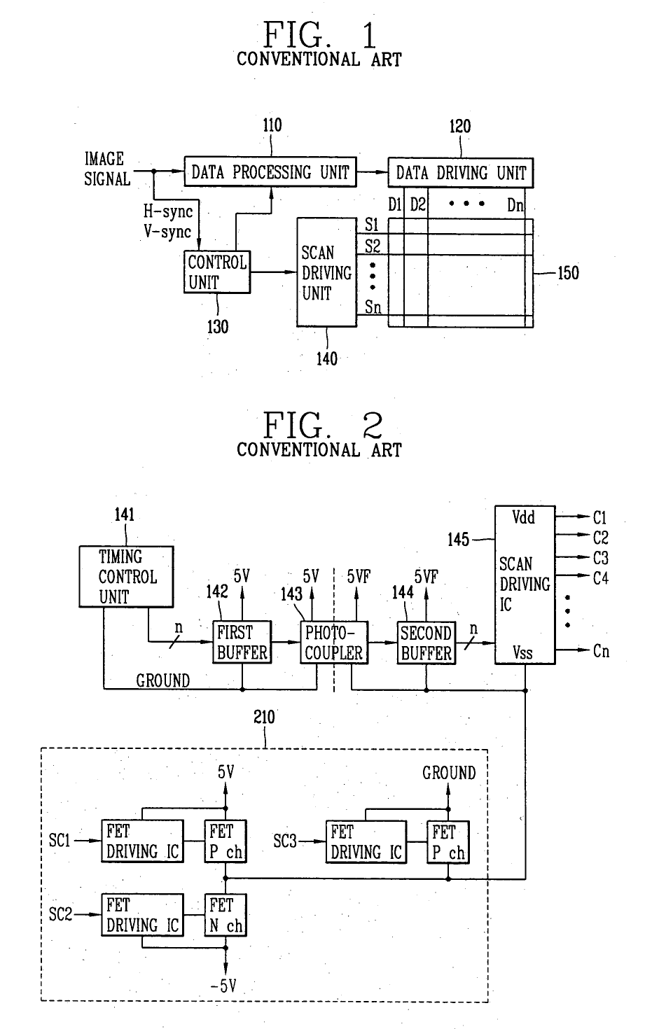

### DETAILED DESCRIPTION OF THE PREFERRED EMBODIMENTS

Hereinafter, a preferred embodiment of an apparatus for driving a flat display panel capable of reducing a unit cost of a product and providing various pulses according to a kind of flat display panel by controlling an upper voltage value and a lower voltage value which are applied to an IC for driving a scan electrode of a flat display panel, will now be described with reference to accompanying drawings.

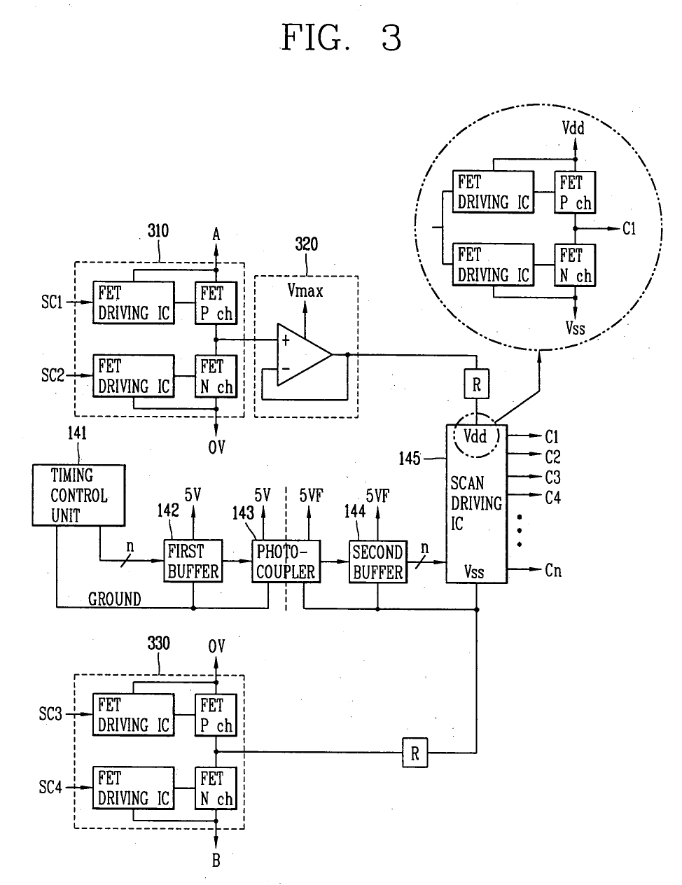

FIG. 3 is a block diagram showing a detailed construction of a scan driving unit in accordance with the present invention.

As shown therein, the scan driving unit in accordance with the present invention includes: a timing control unit 141 for outputting a timing control signal; a first buffer 142 for temporarily storing the timing control signal inputted from the timing control unit 141; a photocoupler 143 for insulating an input terminal and an output terminal for the timing control signal; a second buffer 144 for temporarily storing the timing control signal inputted from the photocoupler 143; an upper voltage generating unit 310 for outputting an upper voltage on the basis of an upper switching control signal; a lower voltage generating unit 330 for outputting a lower voltage on the basis of a lower switching control signal; an amplifying unit 320 for amplifying the upper voltage inputted from the upper voltage generating unit 310 to a predetermined level; and a scan driving IC 145 for selectively outputting at least one of the amplified upper voltage and the lower voltage on the basis of the timing control signal.

At this time, the scan driving IC 145 is includes two FETs (Field Effect Transistor), switching devices, having different channels (n channel, p channel) and two driving ICs for driving the FETs. That is, the scan driving IC 145 selectively turns on one of the switching devices on the basis of the timing control signal inputted from the second buffer 144, thereby selectively outputting one of voltages outputted from the upper voltage generating unit 310 and the lower voltage generating unit 320. In addition, preferably, the amplifying unit 330 comprises an OP-AMP (Operational Amplifier) so as to function as a buffer or an amplifier according to a kind of flat display panel.

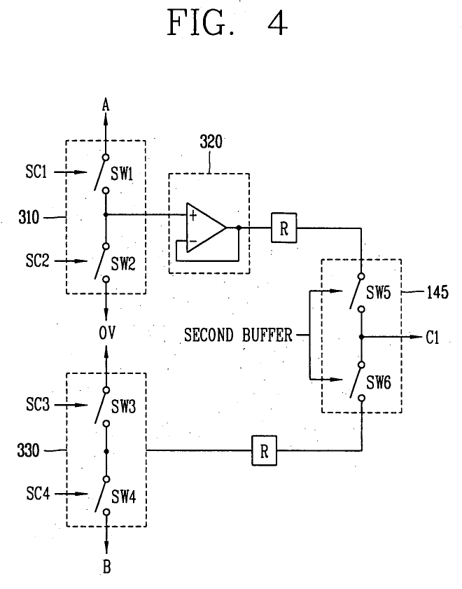

An operation principle of the scan driving unit in accordance with the present invention constructed as above will now be described with reference to FIG. 4.

FIG. 4 is a view for explaining an operation principle of the scan driving unit of FIG. 3.

As shown therein, in the upper voltage generating unit 310, FETs which are turned on/off on the basis of the first and second switching controlling signals (SC1, SC2) function as an SW1 and an SW2, respectively, and in the lower voltage generating unit 320, FETs which are turned on/off on the basis of the third and fourth switching control signals (SC3, SC4) function as an SW3 and an SW4, respectively. In the scan driving IC 145, FETs which are selectively turned on/off on the basis of the timing control signal inputted from the second buffer 144 function as an SW5 and an SW6, respectively.

A method of driving the scan driving unit that is driven through the 6 switches (SW1, SW2, SW3, SW4, SW5, SW6) in accordance with the present invention will now be described in detail.

First, in order to generate a scan pulse of −5V and 0V and a reset pulse of 0V and 5V which are applied to the display panel 150, a voltage of 5V and a voltage of −5V are applied to an A terminal and a B terminal, respectively. Herein, a predetermined voltage is differently applied to A and B terminals according to a kind of flat display panel.

To explain a process of generating a scan pulse of −5V and 0V, the SW2 and the SW3 are turned on by the second and third switching control signals SC2, SC3 outputted from the control unit 130 to apply a voltage of 0V to the scan driving IC 145, and only one of the SW5 and the SW6 is turned on by a timing control signal outputted from the timing control unit 141, so that the scan driving IC 145 outputs a voltage of 0V to the display panel 150. And, the SW4 is turned on by the fourth switching control signal SC4 outputted from the control unit 130 to apply a voltage of −5V to the scan driving IC 145, and the SW6 is turned on by a timing control signal outputted from the timing control unit 141, so that the scan driving IC 145 outputs a scan pulse waveform corresponding to 0V and −5V to the display panel 150.

After the scan pulse has been outputted, when a predetermined time elapses, a reset pulse of 0V and 5V is outputted. To explain a process of generating a reset pulse of 0V and 5V, the SW2 and the SW3 are turned on by the second and third switching control signals SC2, SC3 outputted from the control unit 130 to apply a voltage of 0V to the scan driving IC 145, and only one of the SW5 and the SW6 is turned on by the timing controlling signal outputted from the timing control unit 141, so that the scan driving IC 145 outputs a voltage of 0V to the display panel 150. And, the SW1 is turned on by the first switching control signal SC1 outputted from the control unit 130 to apply a voltage of 5V to the scan driving IC 145, and the SW5 is turned on by the timing control signal outputted from the timing control unit 141, so that the scan driving IC 145 outputs a reset pulse waveform corresponding to 0V and 5V to the display panel 150.

Through such processes, a scan pulse and a reset pulse can be applied to the flat display panel.

In addition, the amplifying unit 320 is only used as a buffer for temporarily storing the upper voltage value, but it may amplify a voltage or a current in response to a need. For example, the amplifying unit 320 can be used as a voltage amplifier by adding resistance in a positive (+) input terminal, a negative (−) input terminal and an output terminal of an OP-AMP, and can be used as a current amplifier for outputting a current of a predetermined level to an emitter by connecting an output terminal of an OP-AMP to a base of a TR (transistor) (not shown) by using a TR, and by applying a predetermined voltage to a collector, to thereby drive a large screen or a high capacity current device. Accordingly, an apparatus for driving a flat display panel in accordance with the present invention does not need a high-priced special scan driving IC, thereby lowering a unit cost of a product.

At this time, when the amplifying unit 320 amplifies a current through the TR, the amount of the currents should be controlled according to a kind of flat display panel or a driving condition, that is, a load of an image signal inputted to a display panel. For example, in order to control the amount of currents, a voltage applied to a collector of the TR is controlled, a voltage applied to an A terminal of the upper voltage generating unit 310 is controlled, or a control voltage which can control an output value (voltage or current) is applied to a negative (−) input terminal of the OP-AMP.

Scan pulses having various forms can be generated according to a kind of flat display panel and a voltage of a scan pulse applied to a display panel by using the present invention as above.

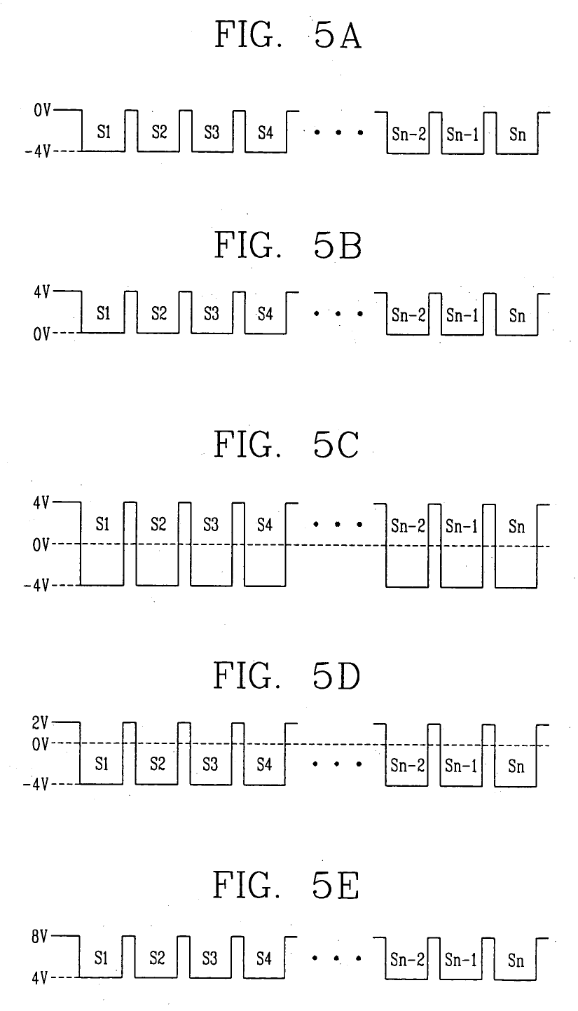

FIG. 5A to 5E are graphs showing various scan pulse waveforms of a scan driving unit in accordance with the present invention.

As shown therein, scan pulse waveforms having various forms can be made by controlling voltages applied to an A terminal and a B terminal of the upper voltage generating unit 310 and the lower voltage generating unit 320.

In addition, a reset pulse for discharging an electric charge which is charged in an electric-discharge cells of a flat display panel by scan pulses having various forms is controlled through the switches, and a width of the reset pulse and a time for applying a reset pulse to a display panel can be determined on the basis of a program control, that is, a switching control signal.

An apparatus for driving a flat display panel in accordance with the present invention can drive a display panel no matter whether a reference voltage level is positive (+) or negative (−) or even when the reference voltage level is varied in various forms. For this reason, the apparatus for driving a flat display panel can be applied to any flat display panels on the basis of a mentioned fundamental operation principle regardless of a kind of devices constructing the panel.

As so far described, an apparatus for driving a flat display panel in accordance with the present invention is advantageous in that a unit cost of a product can be reduced since a high-priced special scan driving IC which can drive a display panel with a relatively high current value is not required by controlling an upper voltage value and a lower voltage value which are applied to an IC for driving a scan electrode of a flat display panel.

In addition, an apparatus for driving a flat display panel in accordance with the present invention is advantageous in that scan pulses having various forms can be provided according to a kind of flat display panel by controlling an upper voltage value and a lower voltage value which are applied to an IC for driving a scan electrode of a flat display panel.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An apparatus for driving a flat display panel comprising a scan driving unit for controlling an upper voltage value and a lower voltage value which are applied to an IC (Integrated Circuit) for driving a scan electrode of a flat display panel.

2. The apparatus of claim 1, wherein the scan driving unit further comprises an amplifying unit for amplifying the upper voltage value to a predetermined level.

3. The apparatus of claim 2, wherein the amplifying unit comprises an OP-AMP (Operational Amplifier).

4. The apparatus of claim 1, wherein the scan driving unit further comprises an amplifying unit for converting the upper voltage value to a current and amplifying the converted current to a predetermined level.

5. The apparatus of claim 4, wherein the amplifying unit comprises an OP-AMP and a TR (transistor) connected to an output terminal of the OP-AMP.

6. The apparatus of claim 1, wherein the scan driving unit comprises:
an upper voltage generating unit for outputting an upper voltage value on the basis of an upper switching control signal; and
a lower voltage generating unit for outputting a lower voltage value on the basis of a lower switching control signal.

7. The apparatus of claim 6, wherein the scan driving unit selectively outputs one of the outputted upper voltage value and the outputted lower voltage value, on the basis of a timing control signal.

8. The apparatus of claim 7 comprises switching devices having a push-pull form turned on/off on the basis of the timing control signal.

9. The apparatus of claim 8, wherein the switching devices comprises a FET (Field Effect Transistor).

10. The apparatus of claim 6, wherein the upper voltage generating unit comprises switching devices having a push-pull form turned on/off on the basis of the upper switching control signal.

11. The apparatus of claim 10, wherein the switching devices comprise a FET (Field Effect Transistor).

12. The apparatus of claim 6, wherein the lower voltage generating unit comprises switching devices having a push-pull form turned on/off on the basis of the upper switching control signal.

13. The apparatus of claim 12, wherein the switching devices comprise a FET (Field Effect Transistor).
